(19) United States
(12) Patent Application Publication
(10) Pub. No.: US 2010/0295302 A1
(43) Pub. Date: Nov. 25, 2010

(54) SYSTEMS AND METHODS FOR A LINEAR HYDROKINETIC GENERATOR

(76) Inventor: Wes Martin, Chesapeake, VA (US)

Correspondence Address: BLACK LOWE & GRAHAM, PLLC, 701 FIFTH AVENUE, SUITE 4800, SEATTLE, WA, 98104, US

(21) Appl. No.: 12/302,437

(22) PCT Filed: Jun. 27, 2008
(86) PCT No.: PCT/US08/68642

§ 371 Date: Nov. 25, 2008

Related U.S. Application Data
(60) Provisional application No. 61/025,764, filed on Feb. 2, 2008.

(51) Int. Cl. H02P 9/04; F03B 13/00

(52) U.S. Cl. 290/43; 290/54

(57) ABSTRACT

A linear hydrokinetic generator assembly generates power. An exemplary embodiment drifts a harnessing surface in a current of fluid away from the generator assembly and draws a cable attached to the harnessing surface from a cable spool as the cable is drawn by the drifting harness surface, wherein the drawn cable rotates the cable spool and generates power from the rotating cable spool.

### PRIORITY CLAIM

This patent application claims the benefit of the filing date of U.S. Provisional Patent Application Ser. No. 61/025,764, filed Feb. 2, 2008, which is hereby incorporated by reference in its entirety.

### TECHNICAL FIELD

The present invention is generally related to power and energy generation and, more particularly, to systems and methods that harness hydrokinetic energy from a unidirectional liquid flow to generate power and energy.

### BACKGROUND OF THE INVENTION

Hydrokinetic generators use foils or turbines to transfer energy derived from a moving body of water to rotate the shaft on an electrical generator, such as disclosed in U.S. Pat. No. 7,190,087, issued on Mar. 13, 2007, entitled “Hydroelectric Turbine and Method For Producing Electricity From Tidal Flow,” which is hereby incorporated by reference in its entirety. The spinning blades disclosed in U.S. Pat. No. 7,190,087 are relatively inefficient in generating power and energy from slow moving hydrokinetic energy.

Non-turbine water power devices may use rails or car devices with sails on them to collect the hydrokinetic energy from moving water. An exemplary non-turbine device is disclosed in U.S. Pat. No. 7,075,191, issued on Jul. 11, 2006, entitled “Wind and Water Power Generation Device Using A Rail System,” which is hereby incorporated by reference in its entirety. Such non-turbine based devices may provide continuous energy to the generator. When used in water, the device disclosed in U.S. Pat. No. 7,075,191 uses a series of vanes mounted on a continuous loop or track that un-feather during their motion downstream and feather as they move upstream. Although this is an effective way to collect hydrokinetic energy, the vanes are relatively small and the mechanics of attaching the vanes to the loop or track is relative complicated and potentially prone to problems from debris in the water.

Accordingly, it is very desirable to generate power from a relatively less complex, non-turbine based system that is reliable, and that is relatively less expensive to manufacture and maintain.

### SUMMARY OF THE INVENTION

Systems and methods of generating power are disclosed. An exemplary embodiment has a cable spool; at least one cable wound around the cable spool a plurality of times; and a harnessing surface coupled to an end of the cable, and configured to drift in a current of fluid away from the generator assembly, wherein the drifting harnessing surface draws the cable from the cable spool to produce power.

In accordance with further aspects, an exemplary embodiment drifts a harnessing surface in a current of fluid away from the generator assembly; draws a cable attached to the harnessing surface from a cable spool as the cable is drawn by the drifting harness surface, wherein the drawn cable rotates the cable spool; and generates power from the rotating cable spool.

### BRIEF DESCRIPTION OF THE DRAWINGS

Preferred and alternative embodiments are described in detail below with reference to the following drawings:

FIG. 1 is a perspective view of an embodiment of the linear hydrokinetic generator;

FIG. 2 is a top view of the embodiment of the linear hydrokinetic generator of FIG. 1;

FIG. 3 is a front view of the harnessing surface of FIGS. 1 and 2;

FIG. 4 is a perspective view of a tandem embodiment of a linear hydrokinetic generator;

FIG. 5 is a top view of the tandem embodiment of the linear hydrokinetic generator of FIG. 4;

FIGS. 6-10 show an alternative embodiment with a single vane harnessing surface;

FIG. 11 illustrates the surface structure coupled to a single cable that is connected to an embodiment of the harnessing surface;

FIG. 12 illustrates a harnessing surface with a plurality of active control fins;

FIG. 13 illustrates an alternative embodiment of a harnessing surface with a plurality of passive control fins;

FIG. 14 illustrates a side view of the harnessing surface of FIG. 13; and

FIG. 15 illustrates a top view of the harnessing surface of FIG. 13.

### DETAILED DESCRIPTION OF THE PREFERRED EMBODIMENT

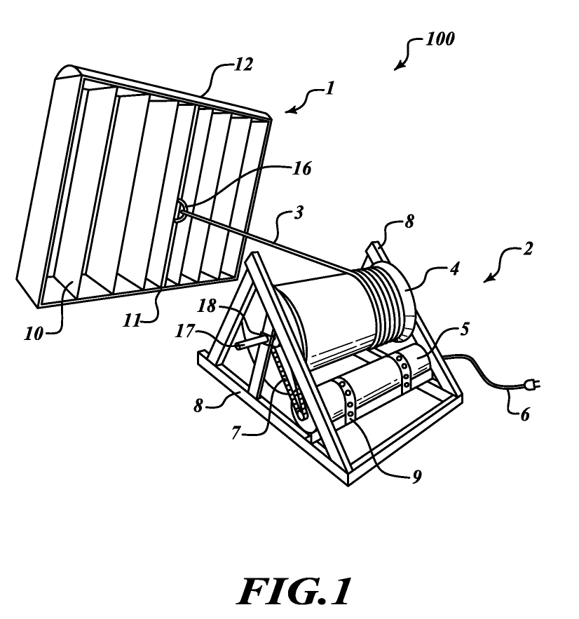

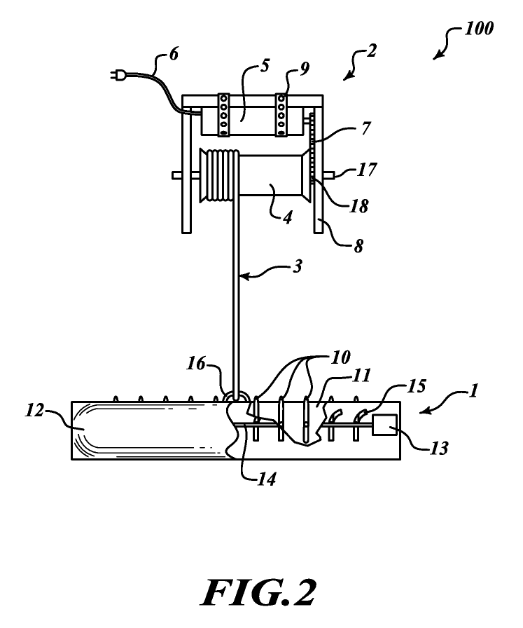

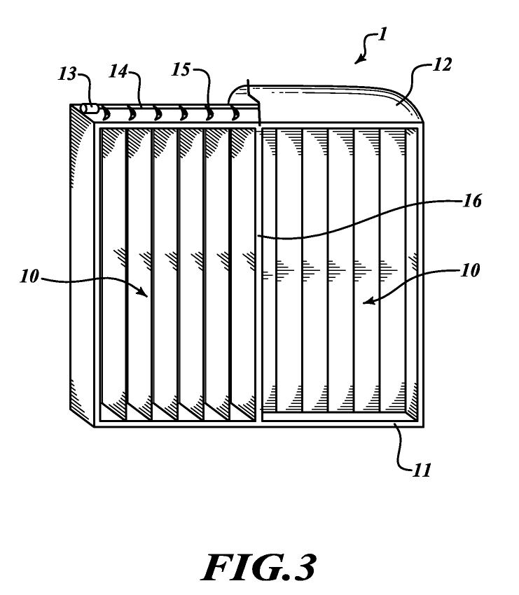

FIG. 1 is a perspective view of an embodiment of the linear hydrokinetic generator 100. FIG. 2 is a top view of the embodiment of the linear hydrokinetic generator 100. FIG. 2 also shows a cut out view of the top of the harnessing surface 1. FIG. 3 is a front view of the harnessing surface 1 of FIGS. 1 and 2.

Embodiments of the linear hydrokinetic generator 100 generate electricity from hydrokinetic energy derived from a relatively slow, unidirectional liquid flow of water, such as an ocean current or river. Embodiments of the linear hydrokinetic generator 100 do not require turbines or rails as other prior art devices. The linear hydrokinetic generator 100 comprises a harnessing surface 1, generator assembly 2, and one or more cables 3. Cables 3 connect the generator assembly 2 to the harnessing surface 1, and transfer the kinetic energy from the harnessing surface 1 to the generator assembly 2, via the cables 3, to generate electricity.

The harnessing surface 1 is pulled by the current away from the generator assembly 2, referred to hereinafter as drifting. Thus, the harnessing surface 1 drifts away from the generator assembly 2. The harnessing surface 1 travels (drifts) in a direction that substantially corresponds to the direction of the current. The drifting harnessing surface 1 draws the cable(s) 3 attached to the harnessing surface 1 from a cable spool 4. The drawn cable 3 rotates the cable spool 4 as the cable 3 is drawn by the drifting harnessing surface 1, thereby generating a torque at the cable spool 4. The torque of the rotating cable spool 4 is used to generate power. For example, in some embodiments, the cable spool 4 is rotatably coupled to the shaft of an electric machine 5 (directly, or indirectly via a shaft or gear system). The shaft of the electric machine 5 is rotated by the applied torque of the cable spool 4 and the electric machine 5 generates electricity (power).

The linear hydrokinetic generator 100 illustrated in FIG. 1 has a cable spool 4 that rotatably releases and retracts the cable 3. The electric machine 5 operates as a generator to generate electricity from the hydrokinetic energy of moving water when its shaft is rotated by dragging the cable 3, tethered to the harnessing surface 1, away from the generator assembly 2, in a sail like manner. When the cable 3 reaches its extent, the vanes of the harnessing surface 1 feathers to greatly reduce its surface area so that the harnessing surface 1 may be pulled back (retrieved) to the generator assembly 2 by a suitable retrieval means. After the harnessing surface 1 has been retrieved, the vanes of the harnessing surface 1 are un-feathered to greatly increase its surface area to the flow of water. The current of the water then drifts the harnessing surface 1 away from the generator assembly 2 and the process is repeated to generate additional electricity.

The generator assembly 2 comprises a frame 8 that is holding the cable spool 4 and the electric machine 5 in a fixed position, such as under the water or above the water. The frame 8 is affixed to a structure or to a vessel. The spool axle 17 functionally secures the cable spool 4 to the frame 8. The cable spool 4 is geared at gears 18 which are connected to the generator 5 by a chain 7. The electric machine 5 is held to the frame by straps 9. A connector 6 protrudes from the electric machine 5 to deliver and/or receive electricity.

When the harnessing surface 1 is suspended in a unidirectional liquid flow, the harnessing surface 1 is drawn away from the generator assembly 2, via cable 3, by the hydrokinetic energy of the liquid in proximity to the harnessing surface 1. As the harnessing surface 1 is drawn away (drifts) from the generator assembly 2 by the liquid flow, the attached cable 3 extends and thereby rotates the cable spool 4. Thus, the cable 3 unwinds and rotates (turns) the cable spool 4 as the harnessing surface 1 is pulled by the liquid flow surrounding the harnessing surface 1. In an exemplary embodiment, the rotational energy from turning the cable spool 4 is transferred to a gearbox that drives an electric machine 5.

When the harnessing surface 1 reaches a limit distance from the generator assembly 2, the vanes 10 of the harnessing surface 1 feather. A limit distance is the extent that the harnessing surface 1 is permitted to drift from the generator assembly 2. The limit distance may be defined based upon some parameter of interest, or may be based on the maximum extent of the cable 3.

Feathering means that the position of the vanes 10 is changed so as to present a relatively low drag surface to the flow of water about the harnessing surface 1. Accordingly, less energy is required to retrieve the harnessing surface 1 (relative to the amount of energy generated by the harnessing surface 1 as the flow of water drifts the harnessing surface 1 from the generator assembly 2).

When the vanes 10 feather, the electric machine 5 then operates as a motor such that the cable spool 4 is turned in an opposite direction to rewind the cable 3. Thus, motor operation of the electric machine 5 retrieves the feathered harnessing surface 1, much like reeling in a fish. When the harnessing surface 1 is fully retrieved, the vanes 10 un-feather, thereby greatly increasing a surface area of the harnessing surface 1 to the incoming water flow, which again drifts the harnessing surface 1 to further generate electricity.

Accordingly, the process of generating power may generally be described by two phases:
1. Generation Phase: when the harnessing surface 1 is configured at a maximum surface area to the passing liquid flow such that the kinetic energy from the moving current drifts the harnessing surface 1 away from the generator assembly 2, preferably in a straight line, and
2. Retrieval Phase: when the harnessing surface 1 is configured at a minimum surface area to the incoming liquid flow and a force is applied to the cable to retrieve the harnessing surface 1 back to the generator assembly 2.

In the embodiment of the linear hydrokinetic generator 100 illustrated in FIGS. 1 and 2, a series of vanes 10 are secured by a hydrodynamic frame 11. The vanes 10 may operate similarly to shutters or the like. A motor 13 is operable to open the vanes 10 during the retrieval phase and close the vanes 10 during the generation phase. As noted above, when the harnessing surface 1 reaches its limit, corresponding to the extent of the cable 3 or to a predefined length of cable 3, an embodiment opens the vanes 10 by turning on the motor 13. The hydrodynamic frame 11 is designed for reducing drag when the vanes 10 are open. In some embodiments, the hydrodynamic frame 11 may also be designed for at least partial stabilization of the harnessing surface during generation phase, passively by use of at least one fin or actively by other mechanical stabilization devices.

On top of the harnessing surface 1 illustrated in FIGS. 2 and 3 is a buoyancy member 12 that is connected to the top side of the hydrodynamic frame 11. The buoyancy member 12 is operable to orient the harnessing surface 1 in a substantially vertical position that is generally perpendicular to the direction of water flow. When underwater, the harnessing surface 1 will preferably neither float nor sink in view of the buoyancy provided by the buoyancy member 12. In one embodiment, the buoyancy member 12 is an underwater suspension air pocket such as a bladder or the like that may have an amount of air or another gas adjusted so as to control the buoyancy, and hence the vertical position of, the harnessing surface 1 below the surface of the water. In another embodiment, the buoyancy member 12 may be a positive buoyancy material, such as styrofoam or the like.

The harnessing surface 1 in FIG. 3 is illustrated as a series of framed vanes 10 that pivot about their axis. The vanes 10 are actuated by a motor 13 and arm 14 that actuate each vane 10 to its open or its closed position. The hydrodynamic frame 11 is partially cut away in FIG. 2 showing the edges of three vanes 10 in an open position.

A motor 13 and a vane-actuating arm 14 are located in a suitable position, such as above the hydrodynamic frame 11. Arms 14 are attached to each vane 10 through the semi-circular vane-actuating holes 15. There are semi-circular vane-actuating holes 15 through the hydrodynamic frame 11. These semi-circular vane-actuating holes 15 provide means for vane control by the vane-actuating arm 14. The vanes 10 are opened (to feather the harnessing surface 1) and closed by the motor 13 during the appropriate phase of generation.

Motor 13 opens the vanes 10 by moving the vanes 10 to a position where the edges of the vanes 10 face the current (thereby feathering the harnessing surface 1). Then, after the vanes 10 are positioned for feathering, the harnessing surface 1 is retrieved. Upon retrieval, the motor 13 closes the vanes 10 and the generation phase is repeated. The motor 13 closes the vanes 10 by moving the vanes 10 to a position where the surface of the vanes 10 face the current (to facilitate the drifting of the harnessing surface 1). The motor 13 may be turned on locally or remotely.

For illustration purposes, FIG. 3 shows the left half of the harnessing surface 1 with the vanes 10 open, and shows the right half of the vanes 10 closed. Preferably, the vanes 10 are all open, or are all closed, because the vanes 10 are operating in cooperation during the generation phase (vanes 10 are closed) or during the retrieval phase (vanes 10 are open). However, for convenience of describing operation of the vanes 10, the vanes 10 in FIG. 3 are shown in both open and closed positions on the hydrodynamic frame 11.

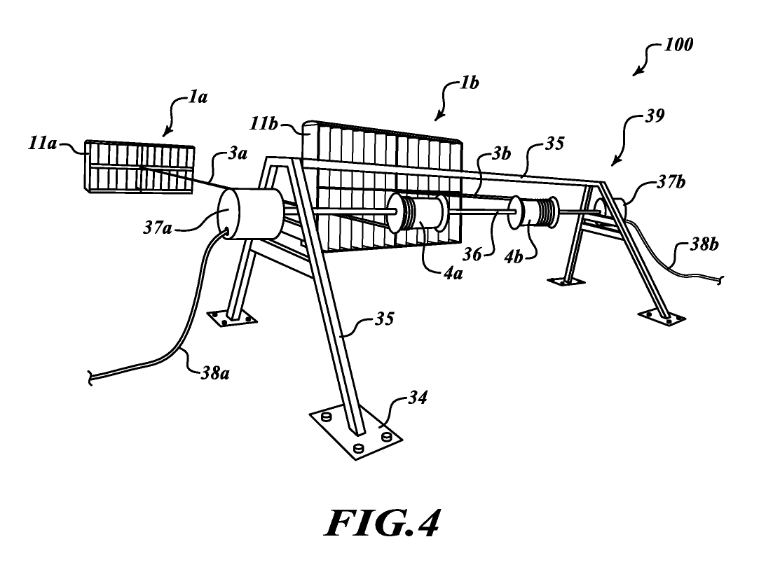

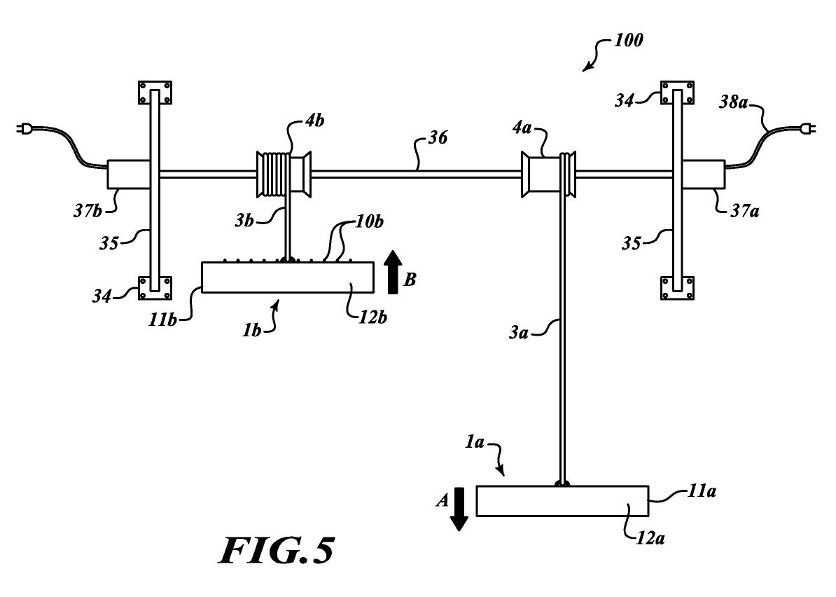

FIGS. 4 and 5 illustrate a tandem embodiment of a linear hydrokinetic generator 100. FIG. 4 is a perspective view of a tandem embodiment of a linear hydrokinetic generator 100. FIG. 5 is a top view of the tandem embodiment of the linear hydrokinetic generator 100 of FIG. 4.

The exemplary tandem linear hydrokinetic generator 100 embodiment uses two harnessing surfaces 1a and 1b, two cable spools 4a and 4b, and two generator assemblies 37a and 37b, respectively. Each generator 37a and 37b has an electrical cord 38a and 38b, respectively, that delivers generated electricity. The generators 37a and 37b are fixed to the axel 36.

In the perspective view in FIG. 4, the harnessing surface 1a on the left is illustrated as operating in the generation phase with its respective vanes 10 in a closed position. Accordingly, the harnessing surface 1a is drifting away from the generator assembly 37a.

Harnessing surface 1b is illustrated as operating in a retrieval phase with its respective vanes 10 in an open position. That is, the harnessing surface 1b is feathered, thereby reducing the drag of the harnessing surface 1b during its retrieval. The harnessing surface 1b is being retrieved by the opposing drifting motion of harnessing surface 1a, which has its vanes 10 closed. Here, harnessing surface 1a has a higher drag coefficient than the feathered harnessing surface 1b. The harnessing surface 1b is retrieved since the cables spools 4a and 4b are oppositely wound such that when the cable 3a is extending (as harnessing surface 1a is being pulled out by the water current acting on its surface), the cable 3b is retracting.

The generator assembly 39 in the tandem linear hydrokinetic generator 100 embodiment of FIGS. 4 and 5 has an A-frame 35 configured like a swing set with anchored footings 34. The exemplary anchored footings 34 have four anchors for each footing, though any suitable number of anchors, or any suitable anchoring means, may be used. Any suitable frame structure may be used for a frame.

The A-frame 35 supports the relatively long single axel 36 that physically couples both of the cable spools 4a and 4b. Separation of the cable spools 4a and 4b keeps the respective harnessing surfaces 1a and 1b separated from each other as they pass by each other during their respective generation and retrieval phases.

In FIG. 5, the arrow “A” indicates the direction of movement of the harnessing surface 1a as the cable 3a is being extended in response to the kinetic force of the moving water on the harnessing surface 1a. Here, harnessing surface 1a is operating electric machine 37a for generating electricity. Arrow “B” indicates an opposite direction of movement of the harnessing surface 1b as it is being retrieved. The vanes 10b of the harnessing surface 1b are open in a feathered configuration, as is apparent from the slightly protruding vane ends from the hydrodynamic frame 11b. Here, the electric machine 37a may be disengaged. Alternatively, electric machine 37a may be operated in a motor mode to assist with the retrieval of the harnessing surface 1b.

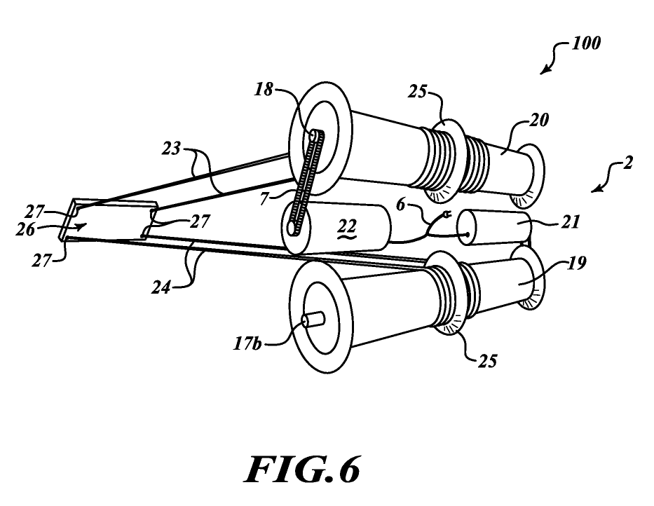

FIGS. 6-10 show an alternative embodiment of a linear hydrokinetic generator 100 that employs a single vane harnessing surface 26. The single vane linear hydrokinetic generator 100 uses a smooth surfaced, single vane harnessing surface 26 secured to two upper cables 23 and two lower cables 24. Upper cables 23 attach to the single vane harnessing surface 26 at the attachment locations 27 in the upper corners. Lower cables 24 attach at the lower corners.

The single vane harnessing surface 26 has a substantially neutral buoyancy built into its construction using any suitable means. Neutral buoyancy may be achieved by selection of materials, use of weights, and/or use of bladders or the like.

The generator assembly 2 in this embodiment has two spools 19 and 20, and two electric machines 21 and 22. The lower spool 19 is bifurcated by a center flange 25 that separates the lower cables 24. The upper spool 20 is bifurcated by a center flange 25 that separates the two upper cables 23. The electric machine 21 is connected to spool 19. The electric machine 22 is connected to the spool 20, via the illustrated chain 7. The electric machines 21 and 22 double as a motor for the retrieval of the single vane harnessing surface 26.

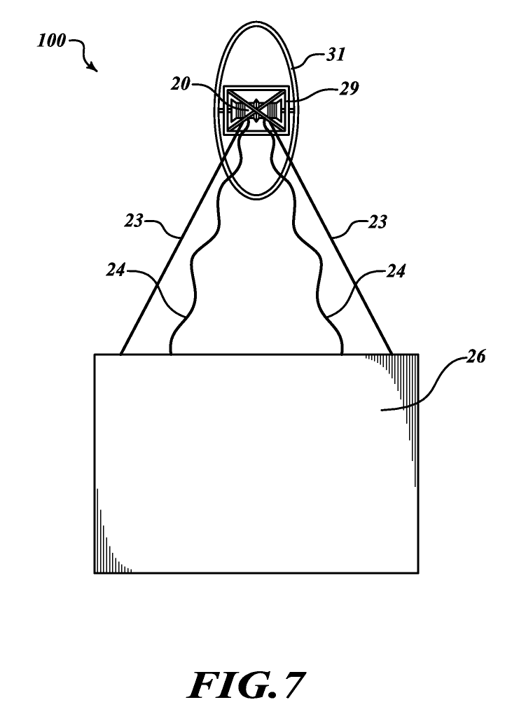

FIG. 7 shows the retrieval phase since the backside of the single vane harnessing surface 26 is facing up (parallel to) the upper cables 23, thus minimizing the surface area to the oncoming current to facilitate the retrieval phase. The single vane harnessing surface 26 feathers passively by pivoting about its horizontal axis. The pivoting is caused by the force of the oncoming water current when the upper cables 23 stop and the lower cables 24 slack. Accordingly, the single vane harnessing surface 26 feathers by stopping the upper cables 23 and releasing slack to the lower cables 24. The current pulls the single vane harnessing surface 26 flat (parallel with the direction of current flow). Then, the upper cables 23 and lower cables 24 are retracted at substantially the same time. FIG. 7 illustrates that lower cables 24 are slightly slacked showing that they are being wound but are not actively involved in the retrieval of the harnessing surface 26.

In one embodiment, when the single vane harnessing surface 26 has been retrieved, the upper cables 23 are given slack while the lower cables 24 are stopped, Accordingly, the single vane harnessing surface 26 un-feathers so as to become perpendicular to the direction of current flow. When the single vane harnessing surface 26 is fully un-feathered, the upper cables 23 and the lower cables 24 are extended by the pulling force of the current exerted on the drifting single vane harnessing surface 26. As the single vane harnessing surface 26 drifts away, the two spools 19 and 20 turn together, thereby applying torque to the two electric machines 21 and 22. In an alternative embodiment, a single electric machine may be coupled to the two spools 19 and 20 when a means for allowing independent control of the upper cables 23 and the lower cables 24 is provided.

In an alternative embodiment, cables attached to one side of the single vane harnessing surface 26 are stopped and cables attached to the opposing side (and cables attached to other sides, if present) are slacked. For example, the above-described upper cables 23 may be slacked and the lower cables 24 may be slacked.

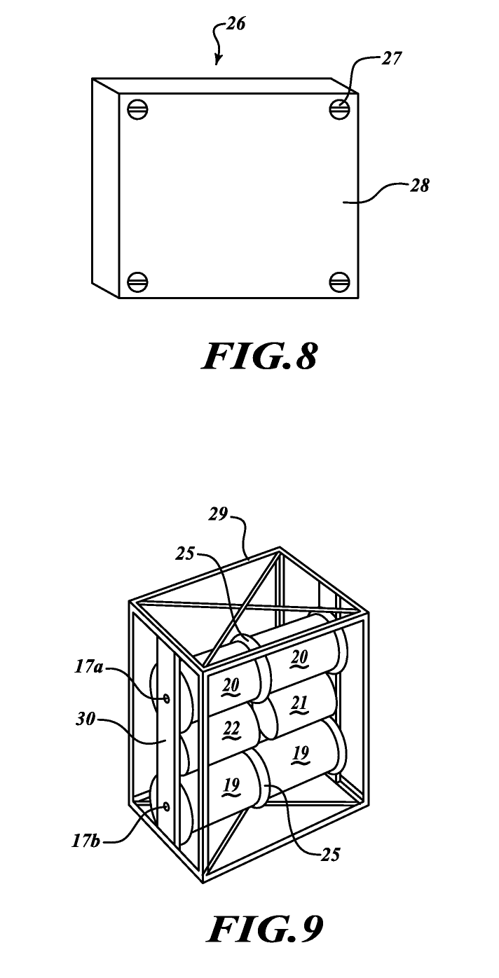

FIG. 8 is a more detailed view of a single vane harnessing surface 26 showing the front side that is facing generator assembly 2. The single vane harnessing surface 26 is illustrated with a smooth surface 28 and four cable attachment locations 27. The single vane harnessing surface 26 is a rectangular shaped surface, though any shaped surface may be used. The exemplary single vane harnessing surface 26 has a greater height and width than depth (thickness) to maximize and minimize the surface area during the respective generation and retrieval phases. The back side of the exemplary single vane harnessing surface 26 (not shown) does not need to have cable attachment locations.

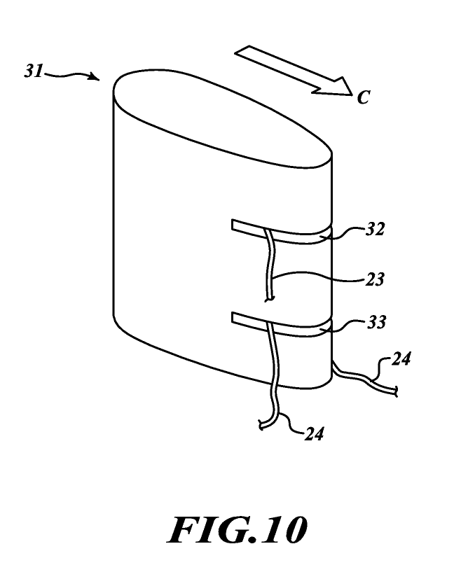

As noted above, FIG. 9 shows the generator assembly frame 29. The frame 29 is simple and boxlike. Vertical members 30a and 30b support the upper and lower spools by their axels 17a and 17b. The axels 17a and 17b support both of the electric machines 21 and 22. The frame 29, as illustrated in FIG. 9, secures the spools 19 and 20 and the electric machines 21 and 22. The hydrodynamic covering 31 (see FIG. 10) attaches to the frame 29.

FIG. 10 is a perspective view of the hydrodynamic covering 31. The hydrodynamic covering 31 covers the frame 39, the spools 19 and 20, and the electric machines 21 and 22, illustrated in FIGS. 6 and 9. The hydrodynamic covering 31 is configured to decrease the drag from the oncoming current on the generator assembly 2. Arrow “C” illustrates a direction of water flow about the hydrodynamic covering 31. The upper cable opening 32 and the lower cable opening 33 are on the downstream side of the hydrodynamic covering 31.

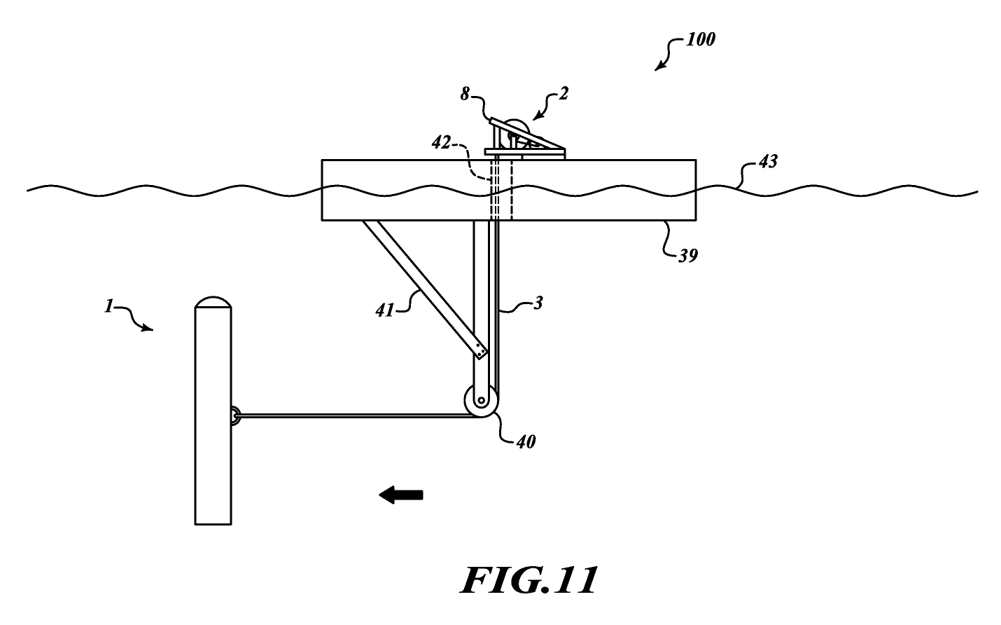

FIG. 11 is a view of a configuration of a frame 8 and the generator assembly 2 resting out of the water on a surface structure 39. In this exemplary embodiment, the surface structure 39 has an optional hole 42 whereby the cable 3 extends into the water and under the waterline 43. The cable 3 is guided by a pulley wheel 40 or the like that is supported by a pulley assembly 41. The surface structure 39 shows a portion of the hole 42. The arrow shows the direction of the current. Alternatively, the pulley assembly 41 may be located on the side or back of the surface structure 39 such that the hole 42 is omitted.

Examples of surface structure 39 include, but are not limited to, a vessel, a structure located on a bank of water, a structure located on (or even part of) a structure anchored in the water (e.g.: a drilling rig, an oil rig, a pier, a dock, a buoy, a lighthouse, etc.). As another non-limiting example, the surface structure 39 may be floating in the water and secured in a substantially fixed position to a nearby bank, the bottom of the water, or another structure.

FIG. 11 illustrates the surface structure 39 coupled to a single cable 3 that is connected to an embodiment of the harnessing surface 1 of FIG. 1. Alternative embodiments of the linear hydrokinetic generator 100 may be configured for mounting on the surface structure 39. For example, the frames 35 and 29 (FIGS. 5 and 9, respectively) may be secured to the surface structure 39 with a suitable pulley assembly 41 operable to guide a plurality of cables coupled to one or more harnessing surfaces 1.

Computer aided automation of the generation phase and the retrieval phase may be used to control the operation of the linear hydrokinetic generator 100 such that the cables are extended and retracted in a coordinated manner. Other embodiments may use firmware or the like. Yet other embodiments may be entirely mechanical.

The various embodiments above have not been described with respect to size. The linear hydrokinetic generators 100 may be relatively large or relatively small depending upon the particular application at hand and/or the nature of the body of water where the linear hydrokinetic generator 100 is operated. Further, the length that the harnessing surface 1 extends during the generation phase may be selectable based upon the particular application at hand and/or the nature of the body of water where the linear hydrokinetic generator 100 is operated. In some embodiments, the extension length is adjustable to provide for operation during different conditions and/or locations.

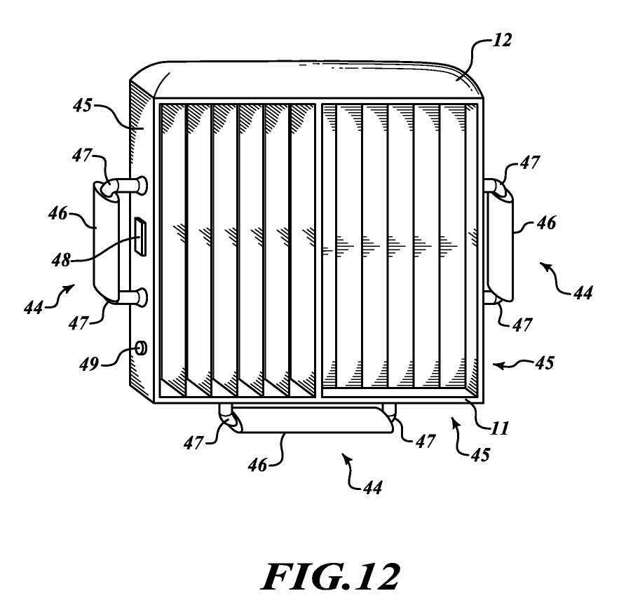

FIG. 12 illustrates an exemplary harnessing surface 1 with a plurality of active control fin structures 44 on the side walls 45 of the harnessing surface 1. Each active control fin structure 44 comprises at least one active control fin 46 and at least one support 47.

The position of the active control fins 46 is adjusted by a suitable control system 48. Sensors 49 may sense the orientation of the harnessing surface 1 and/or position of the active control fins 46, and provide the sensed information to the control system 48. The control system 48 then determines adjustments to the position of the active control fins 46 to orient the harnessing surface 1 in a desired position. The control system 48 may operate the control fin structures 44 in a predefined manner. In some embodiments, the control system 48 may operate the control fin structures 44 in a dynamic manner to dynamically adjust orientation of the harnessing surface 1 on a real-time basis. The control system 48 may be located on the harnessing surface 1 as illustrated in FIG. 12. Alternatively, the control system 48 may be remotely located and control the position of the active control fins 46 via a suitable communication system that uses wireless or wire-based communication media.

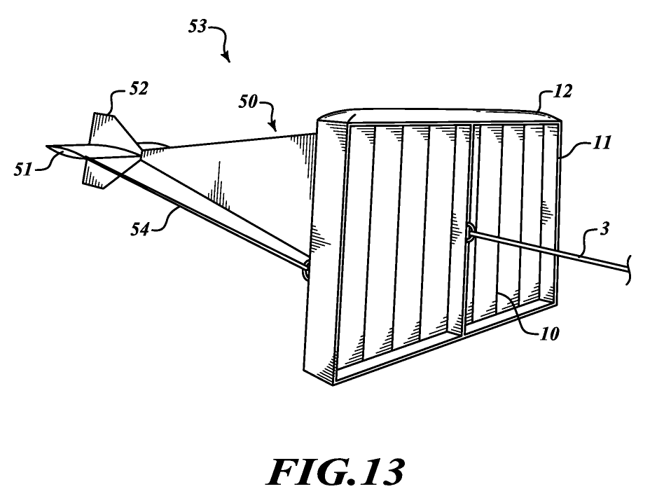

The number and/or location of the control fin structures 44 may be determined based upon the particular application at hand and/or the nature of the body of water where the linear hydrokinetic generator 100 is operated. For example, control fin structures 44 may be located on the sides of the harnessing surface 1, on the bottom and/or on the top of the harnessing surface 1. Multiple control fin structures 44 may be located on a single side wall 45. The active control fin structures 44 can be designed to work with passive control fin structure 53 (FIGS. 13-15) for enhancing control of the harnessing surface 1 during both phases respectively.

FIG. 13 illustrates a plurality of passive control fins 50-52. The passive control fin structure 53 comprises of a central fin 50 extending back from the hydrodynamic frame 11 in the exemplary harnessing surface 1. Vertical fins 52 and horizontal fins 51 are located at the end of the central fin 50. In this embodiment. the passive control fin structure 53 is supported by a pair of guy wires 54 attached to the hydrodynamic frame 11, for example, at the leading edge corner of the horizontal tail fins 51. Guy wires 54 may be attached at ant suitable location, and any number of guy wires 54 may be used.

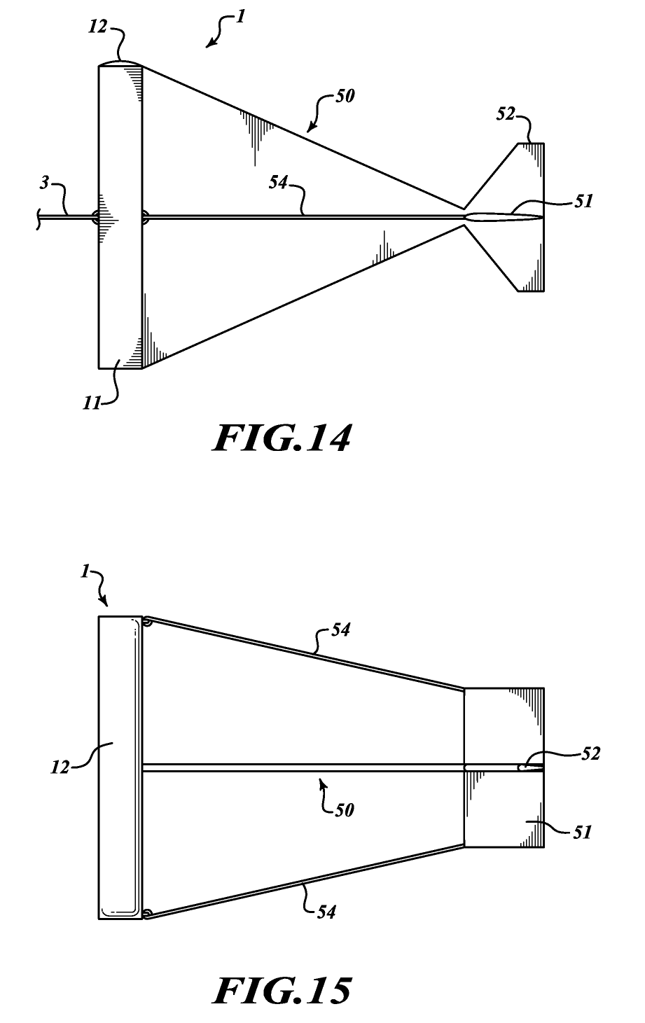

FIG. 14 illustrates the side view of the harnessing surface 1 with a plurality of passive control fins 50-52 shown in FIG. 13. The central fin 50 may be a solid frame extension. Another embodiment may have the control fins 50-52 extending above or below the sides of the hydrodynamic frame 11.

FIG. 15 illustrates the top view of the harnessing surface 1 with a plurality of passive control fins 50-52 shown in FIG. 13. This top view shows the guy wires 54 used as structural support for the passive control fins 50-52. The guy wires 54 are fixed from the trailing edge of the hydrodynamic frame 11 extending back to the horizontal control fins 51.

Embodiments of the linear hydrokinetic generator 100 have been described herein as being operable to generate electricity from kinetic energy derived from a flow of water. Alternative embodiments may generate power from kinetic energy derived from a flow of a different fluid, such as air. For example, the harnessing surface 1 may be a kite or the like that is operable to extend a cable 3 in the wind. Further, the harnessing surface 1 may not be fully submerged. For example, the harnessing surface 1 may float on the surface of the water and drift in the current.

Embodiments of the linear hydrokinetic generator 100 have been described herein as being operable to generate electrical power (electricity) as the harnessing surface 1 drifts away from the generator assembly 2. In the various embodiments, cable 3 rotates the cable spool 4 as the cable 3 is drawn by the drifting harnessing surface 1. In alternative embodiments, the generator assembly 2 may have other power conversion devices that are operable to convert the rotational torque of the cable spool 4 into other forms of useful power. For example, the hydrokinetic energy of the drifting harnessing surface 1, which rotates the cable spool 4, may provide mechanical power to drive a pump, compressor, pulley system, or other device.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for generating power, comprising:
drifting a harnessing surface in a current of fluid away from a generator assembly;
drawing a cable attached to the harnessing surface from a cable spool as the cable is drawn by the drifting harness surface, wherein the drawn cable rotates the cable spool; and
generating power from the rotating cable spool.

2. The method of claim 1, wherein generating power from the rotating cable spool comprises generating electricity from an electrical machine coupled to the cable spool.

3. The method of claim 1, wherein after the cable is drawn from the cable spool to a predefined extent, the method further comprises:
feathering the harnessing surface to reduce an amount of drag of the harnessing surface; and
retracting the cable onto the cable spool to retrieve the feathered harnessing surface.

4. The method of claim 3, wherein feathering the harnessing surface comprises turning at least one vane to have an edge of the vane facing the current.

5. The method of claim 3, wherein feathering the harnessing surface comprises releasing an edge of the harnessing surface such that an opposing edge of the harnessing surface is facing the current.

6. The method of claim 3, further comprising:
unfeathering the harnessing surface to increase the amount of drag of the harnessing surface;
again drawing the cable attached to the harnessing surface from the cable spool as the cable is drawn by the drifting harness surface, wherein the drawn cable rotates the cable spool; and
again generating power from the rotating cable spool.

7. The method of claim 3, wherein generating power from the rotating cable spool comprises generating electricity from an electrical machine coupled to the cable spool by operating the electrical machine to retract the cable onto the cable spool.

8. The method of claim 1, wherein the harnessing surface is submersed below a surface of the fluid.

9. The method of claim 1, further comprising adjusting an amount of gas adjusted in a buoyancy member to control vertical position of the harnessing surface.

10. A linear hydrokinetic generator assembly, comprising:
a cable spool;
at least one cable wound around the cable spool a plurality of times; and
a harnessing surface coupled to an end of the cable, and configured to drift in a current of fluid away from the generator assembly, wherein the drifting harnessing surface draws the cable from the cable spool to produce power.

11. The linear hydrokinetic generator assembly of claim 10, further comprising an electric machine operable to generate electricity from a torque applied from the rotating cable spool and the harnessing surface drifts in the current and draws out the cable from the cable spool.

12. The linear hydrokinetic generator assembly of claim 11, wherein the electric machine is operable to wind the cable onto the cable spool to retrieve the harnessing surface after the harnessing surface is feathered.

13. The linear hydrokinetic generator assembly of claim 10, wherein the cable spool is a first cable spool, and wherein the at least one cable is an at least one first cable attached to a first edge of the harnessing surface, and further comprising:
a second cable spool;
at least one second cable wound around the second cable spool and attached to a second edge of the harnessing surface, the second edge opposing the first edge, where in response to drawing the first cable to a predefined extent by the drifting harnessing surface, rotation of the first cable spool stops and rotation of the second cable spool continues such that the second cable slacks to feather the harnessing surface, and
wherein the first cable is retracted onto the first cable spool to retrieve the feathered harnessing surface.

14. The linear hydrokinetic generator assembly of claim 10, wherein the harnessing surface comprises:
at least one vane; and
a motor operable to move the vane to a first position wherein a surface of the vane faces the current, and operable to move the vane to a second position wherein an edge of the vane faces the current.

15. The linear hydrokinetic generator assembly of claim 10, wherein the harnessing surface is a first harnessing surface, wherein the cable spool is a first cable spool, wherein the at least one cable is an at least one first cable, and wherein the first cable is drawn from the first cable spool to produce a first amount of power, and further comprising:
a second cable spool;
at least one second cable wound around the second cable spool; and
a second harnessing surface coupled to an end of the second cable, and configured to drift in the current of fluid away from the generator assembly, wherein the second cable is drawn from the second cable spool to produce a second amount of power,
wherein a portion of the second amount of power produced by the drifting second harnessing surface is used to retract the first cable, thereby retrieving the feathered first harnessing surface, and
wherein a portion of the first amount of power produced by the drifting first harnessing surface is used to retract the second cable, thereby retrieving the feathered second harnessing surface.

16. The linear hydrokinetic generator assembly of claim 10, further comprising a buoyancy member configured to adjust an amount of gas to control vertical position of the harnessing surface.

17. The linear hydrokinetic generator assembly of claim 10, further comprising at least one control fin coupled to an edge of the harnessing surface to control position of the harnessing surface.

18. The linear hydrokinetic generator assembly of claim 17, wherein the at least one control fin is an active control fin.

19. A system for generating power, comprising
means for drifting a harnessing surface in a current of fluid away from a generator assembly;
means for drawing a cable attached to the harnessing surface from a cable spool as the cable is drawn by the drifting harness surface, wherein the drawn cable rotates the cable spool; and
means for generating power from the rotating cable spool.

20. The system of claim 19, further comprising:
means for feathering the harnessing surface to reduce an amount of drag of the harnessing surface; and
means for retracting the cable onto the cable spool to retrieve the feathered harnessing surface.
